(19) United States
(12) Patent Application Publication
(10) Pub. No.: US 2004/0256970 A1
(43) Pub. Date: Dec. 23, 2004

(54) Color cathode ray tube and method of manufacturing the same

(76) Inventors: Tohru Takahashi, Tokyo (JP); Takuya Mashimo, Tokyo (JP); Hiroyuki Oda, Tokyo (JP); Takeshi Nakayama, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/817,821

(22) Filed: Apr. 6, 2004

Related U.S. Application Data
(63) Continuation of application No. PCT/JP03/09049, filed on Jul. 16, 2003.

(30) Foreign Application Priority Data
Aug. 6, 2002 (JP) 2002-228258

(51) Int. Cl. H01J 29/81; H01J 29/07

(52) U.S. Cl. 313/402; 313/403; 313/407

(57) ABSTRACT

A shadow mask is composed of a main mask and a sub-mask lapped on each other. Each smaller hole that opens in the main mask has a diameter gradually reduced toward each larger hole, and each smaller hole that opens in the sub-mask has a substantially fixed diameter or a diameter gradually increased toward each larger hole. In this configuration, no part of the smaller-hole-side surface of the sub-mask is hit by an electron beam, so that the electron beam is reflected by a sidewall surface of the main mask only. Thus, a satisfactory screen can be obtained without causing undesired distinctions in brightness or belt-shaped boundaries to appear on the display screen.

### CROSS-REFERENCE TO RELATED APPLICATIONS

This is a Continuation Application of PCT Application No. PCT/JP03/09049, filed Jul. 16, 2003, which was not published under PCT Article 21(2) in English.

This application is based upon and claims the benefit of priority from prior Japanese Patent Application No. 2002-228258, filed Aug. 6, 2002, the entire contents of which are incorporated herein by reference.

### BACKGROUND OF THE INVENTION

1. Field of the Invention

This invention relates to a color cathode ray tube having a shadow mask and a method of manufacturing the same.

2. Description of the Related Art

In general, a color cathode ray tube comprises an envelope, having a panel, and a substantially rectangular shadow mask located in the envelope. A phosphor screen is formed on the inner surface of the panel. The shadow mask is opposed to the phosphor screen. A large number of apertures for use as electron beam passage apertures are formed in a given array in an effective surface of the shadow mask that faces the phosphor screen. The shadow mask serves to screen three electron beams that are emitted from an electron gun by the apertures, and to land them on three-color phosphor layers that constitute the phosphor screen.

Recently, flat tubes are becoming prevailing color cathode ray tubes that can reduce external light reflection and image distortion to improve visibility. The panel outer surface of one such flat tube is substantially flat, having a curvature radius of 10,000 mm or more. Normally, the effective surface of the shadow mask that faces the phosphor screen is shaped corresponding to the inner surface shape of the panel. Therefore, the shadow mask of the flat tube is substantially flat, having a curvature smaller than that of a conventional color cathode ray tube.

However, use of the small-curvature shadow mask arouses the following problems.

Normally, the shadow mask is formed of a metal sheet having a thickness of about 0.22 to 0.25 mm. If the curvature of its effective surface is small, the shadow mask for large-screen use that is formed of such a thin sheet is deformed by its own weight or external force, making it hard to maintain the curved mask surface. Thus, if the curvature of the effective surface is lessened, the retention force (hereinafter referred to as curved mask surface strength) lowers. In particular, the curved mask surface strength is lowest near the center of the effective surface or the center of the screen.

If the curved mask surface strength is low, the effective surface of the shadow mask is inevitably deformed by a very small external force during manufacture or transportation. If the shadow mask is deformed, the distance relation between the apertures of the shadow mask and the inner surface of the panel varies. In consequence, the electron beams that are emitted from the electron gun fail to land on the given phosphor layers, thereby causing a color drift.

Although the lowering of the curved mask surface strength never causes deformation of the shadow mask, the effective surface of the mask is easily resonated by vibration such as voice when the mask is incorporated in a television set, so that unwanted-irregularities in brightness are inevitably reflected on the screen.

The easiest way to prevent the lowering of the curved mask surface strength is to increase the thickness of the shadow mask. If the shadow mask thickness increases, however, it is hard to control the etching of the shadow mask in the manufacturing the same, and the diameter of the electron beam passage apertures is subject to variation. In consequence, the yield of products in the shadow mask manufacture or color cathode ray tube manufacture is reduced, or the screen quality level is lowered, inevitably.

According to a cathode ray tube disclosed in Jpn. Pat. Appln. KOKAI Publication No. 2002-197989, for example, in order to solve these problems, a sub-mask is stuck on the shadow mask near its minor axis to maintain the curved mask surface. With this construction, the curved mask surface can be maintained efficiently.

Normally, as described above, the shadow mask is provided with a large number of apertures. Conventionally, in order to obtain these apertures industrially efficiently, the apertures are formed by etching. There are various methods of etching, and mainly two methods are employed in the manufacture of shadow masks. One of the methods is a one-step etching method called double-sided etching, and the other is a two-step etching method called two-step etching.

The double-sided etching involves simple processes and enables low-cost manufacture of shadow masks. This method, however, is liable to cause variation or irregularities of apertures, and it only enables the manufacture of relatively large apertures.

In the two-step etching, the apertures are formed in two separate steps, thus the method involves complicated processes and entails high manufacturing cost. When compared with the double-sided etching, on the other hand, this method is less liable to cause variation of apertures or irregularities of mask apertures. According to this method, the shadow mask can be manufactured having relatively small apertures. It is preferred, therefore, that high-definition color cathode ray tubes be manufactured by using the two-step etching.

The above-described color cathode ray tube in which two shadow masks are stuck together has the following problems. If the strength of the sub-mask is low, in a configuration such that the two masks manufactured by the two-step etching are stuck together, the strength of the entire mask may possibly be rendered lower. Thus, the strength of the sub-mask itself must be improved.

An overlapping portion in which the sub-mask is lapped on the main mask and non-overlapping portions that are formed of the main mask only are different in the state of unwanted light emission from a phosphor surface that is attributable to electron beam reflection. If the phosphor surface is exposed with use of the shadow mask in the manufacture of the color cathode ray tube, the width of the phosphor layers varies between that part of the formed phosphor surface which corresponds to the overlapping portion and the parts corresponding to the non-overlapping portions.

If an image is displayed by means of the color cathode ray tube described above, therefore, the state of image display varies between the region corresponding to the overlapping portion of the shadow mask and the regions corresponding to the non-overlapping portions. Thus, belt-shaped boundaries may possibly appear between the regions, thereby lowering the image quality.

### BRIEF SUMMARY OF THE INVENTION

This invention has been made in consideration of the above circumstances, and its object is to provide a color cathode ray tube, which enjoys good curved mask surface strength and a satisfactory image quality level, and a method of manufacturing the same.

In order to achieve the above object, a color cathode ray tube according to an aspect of the invention comprises a panel having a phosphor screen on the inner surface thereof, an electron gun which emits electron beams toward the phosphor screen, and a substantially rectangular shadow mask located opposite the phosphor screen inside the panel and having a major axis and a minor axis extending at right angles to each other and to a tube axis.

The shadow mask includes a main mask having a substantially rectangular porous portion opposed to substantially the whole surface of the phosphor screen and having a number of electron beam passage apertures, and a belt-shaped sub-mask fixed to a region containing the minor axis of the porous portion of the main mask, having a number of electron beam passage apertures corresponding individually to the electron beam passage apertures of the main mask, and a longitudinal direction of the sub-mask being on the minor axis.

Each of the electron beam passage apertures of the main mask is defined by a through hole in which a larger hole opening on the surface of the main mask on the phosphor-screen side internally connects with a smaller hole opening on the surface of the main mask on the electron-gun side. Each of the electron beam passage apertures of the sub-mask is defined by a through hole in which a larger hole opening on one surface of the sub-mask internally connects with a smaller hole opening on the other surface of the sub-mask. Each of the smaller holes of the main mask has a diameter gradually-reduced from the electron-gun-side surface of the main mask toward the larger hole, and each of the smaller holes of the sub-mask has a substantially fixed diameter or a diameter gradually increased from the other surface of the sub-mask toward the larger hole.

A method of manufacturing a color cathode ray tube, according to another aspect of this invention, is for a color cathode ray tube which comprises a panel having a phosphor screen on the inner surface thereof, an electron gun which emits electron beams toward the phosphor screen, and a substantially rectangular shadow mask located opposite the phosphor screen inside the panel and having a major axis and a minor axis extending at right angles to each other and to a tube axis. The shadow mask comprises a main mask having a substantially rectangular porous portion opposed to substantially the whole surface of the phosphor screen and formed having a number of electron beam passage apertures, and a belt-shaped sub-mask fixed to a region containing the minor axis of the porous portion of the main mask, having a number of electron beam passage apertures corresponding individually to the electron beam passage apertures of the main mask, and a longitudinal direction of which is on the minor axis.

The manufacturing method comprises preparing a flat mask blank for the main mask and a flat mask blank for the sub-mask, etching the mask blank for the main mask by two-step etching, thereby forming a plurality of electron beam passage apertures each defined by a through hole in which a larger hole opening on one surface of the mask blank internally communicates with a smaller hole opening on the other surface of the mask blank, etching the mask blank for the sub-mask by double-sided etching, thereby forming a plurality of electron beam passage apertures each defined by a through hole in which a larger hole opening on one surface of the mask blank internally communicates with a smaller hole opening on the other surface of the mask blank, fixing together the mask blank for the main mask and the mask blank for the sub-mask, each having the electron beam passage apertures, and press-molding the fixed mask blanks into a desired shape, thereby forming the shadow mask.

According to the color cathode ray tube and its manufacturing method arranged in this manner, each smaller hole of the main mask is configured to have a diameter gradually reduced from the electron-gun-side surface of the main mask toward the larger hole, and each smaller hole of the sub-mask is configured to have a substantially fixed diameter or a diameter gradually increased from the other surface of the sub-mask toward the larger hole. Thus, a satisfactory strength of the sub-mask can be secured, and an overlapping portion in which the sub-mask is lapped on the main mask and non-overlapping portions that are formed of the main mask only can substantially share the state of unwanted light emission from a phosphor surface that is attributable to electron beam reflection. Thus, the shadow mask can enjoy good curved mask surface strength, and the resulting color cathode ray tube can ensure a satisfactory image quality.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a sectional view of a color cathode ray tube according to an embodiment of this invention including its major axis;

FIG. 2 is a sectional view of the color cathode ray tube including its minor axis;

FIG. 3A is a perspective view showing a shadow mask of the color cathode ray tube;

FIG. 3B is an enlarged plan view showing electron beam passage apertures of the shadow mask;

FIG. 4 is a sectional view of the shadow mask taken along its major axis;

FIG. 5 is a sectional view of the shadow mask taken along its minor axis;

FIG. 6 is an enlarged sectional view showing a main mask and a sub-mask of the shadow mask;

FIGS. 7A to 7F are sectional views individually showing two-step etching processes for the main mask;

FIG. 8A is a plan view showing a mask blank used in the manufacture of the main mask;

FIG. 8B is a plan view showing a mask blank used in the manufacture of the sub-mask;

FIGS. 9A to 9D are sectional views individually showing double-sided etching processes for the sub-mask;

FIG. 10A is a sectional view schematically showing an aperture formed by two-step etching and an aperture formed by double-sided etching, the apertures overlapping each other;

FIG. 10B is a sectional view schematically showing the aperture formed by the two-step etching and the aperture formed by the double-sided etching, the apertures overlapping each other;

FIG. 11 is a sectional view showing how an electron beam is passed and reflected in the shadow mask;

FIG. 12 is a sectional view showing a shadow mask of a color cathode ray tube according to another embodiment of the invention; and

FIG. 13 is an enlarged sectional view showing an aperture portion of the shadow mask according to the alternative embodiment.

### DETAILED DESCRIPTION OF THE INVENTION

A color cathode ray tube according to an embodiment of this invention will now be described in detail with reference to the drawings.

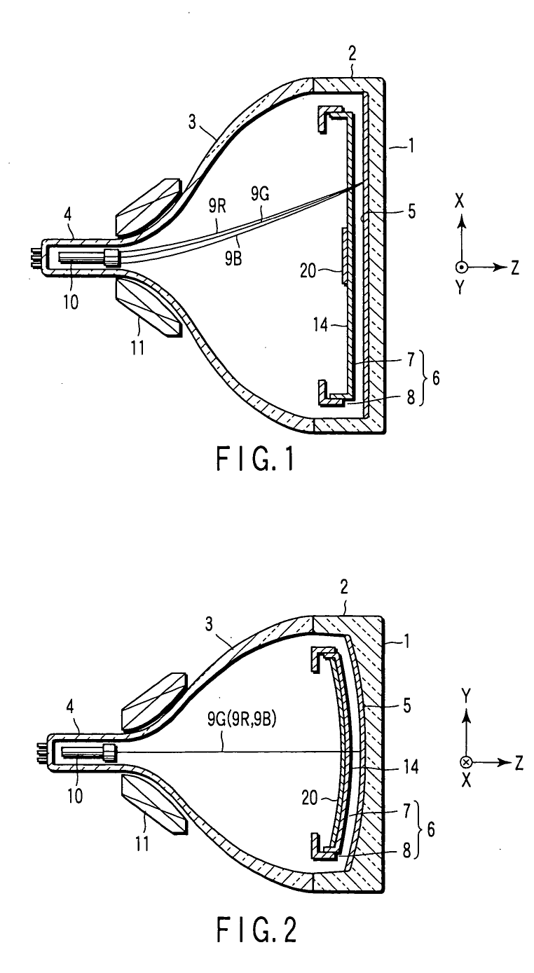

As shown in FIGS. 1 and 2, a color cathode ray tube comprises an envelope of glass. This envelope has a rectangular panel 1 with a skirt portion 2 on its peripheral edge portion, a funnel 3 joined to the skirt portion 2, and a neck 4 extending from a small-diameter portion of the funnel 3. A phosphor screen 5 is formed on the inner surface of the panel 1. The envelope has a tube axis Z passing through the respective centers of the panel 1 and the neck 4, a major axis (horizontal axis) X extending at right angles to the tube axis, and a minor axis (vertical axis) Y extending at right angles to the tube axis and the major axis.

If the case of a 32-inch, wide-type color cathode ray tube having a screen aspect ratio of 16:9 and a screen effective diameter of 76 cm, the outer surface of the panel 1 is substantially flat, having a curvature radius of 100,000 mm. The inner surface of the panel 1 is substantially cylindrical, having a radius of curvature of about 7,000 mm along the X-axis and on the X-axis and a curvature radius of about 1,500 mm along the Y-axis and on the Y-axis.

In the envelope, a shadow mask structure 6 that functions as a color selecting electrode is opposed to the phosphor screen 5. The shadow mask structure 6 includes a shadow mask 7, having a number of apertures as electron beam passage apertures, and a mask frame 8 in the form of a rectangular frame with an L-shaped cross section to which the peripheral portion of the shadow mask 7 is fixed. The shadow mask structure 6 is supported on the inside of the panel 1 in a manner such that a plurality of elastic supports (not shown) on the sidewall of the mask frame 8 are anchored individually to stud pins (not shown) that are embedded in the skirt portion 2 of the panel 1. The opening of each electron beam passage hole in the shadow mask 7 has a rectangular or circular shape, depending on the way of use.

Located in the neck 4 is an electron gun 10, which emits three electron beams 9R, 9G and 9B that are arranged in a line on the major axis X. In the color cathode ray tube described above, the electron beams 9R, 9G and 9B that are emitted from the electron gun 10 are deflected by means of a deflection yoke 11 that is attached to the outside of the funnel 3. An image is displayed in a manner such that the phosphor screen 5 is scanned horizontally and vertically with the electron beams with the aid of the shadow mask 7.

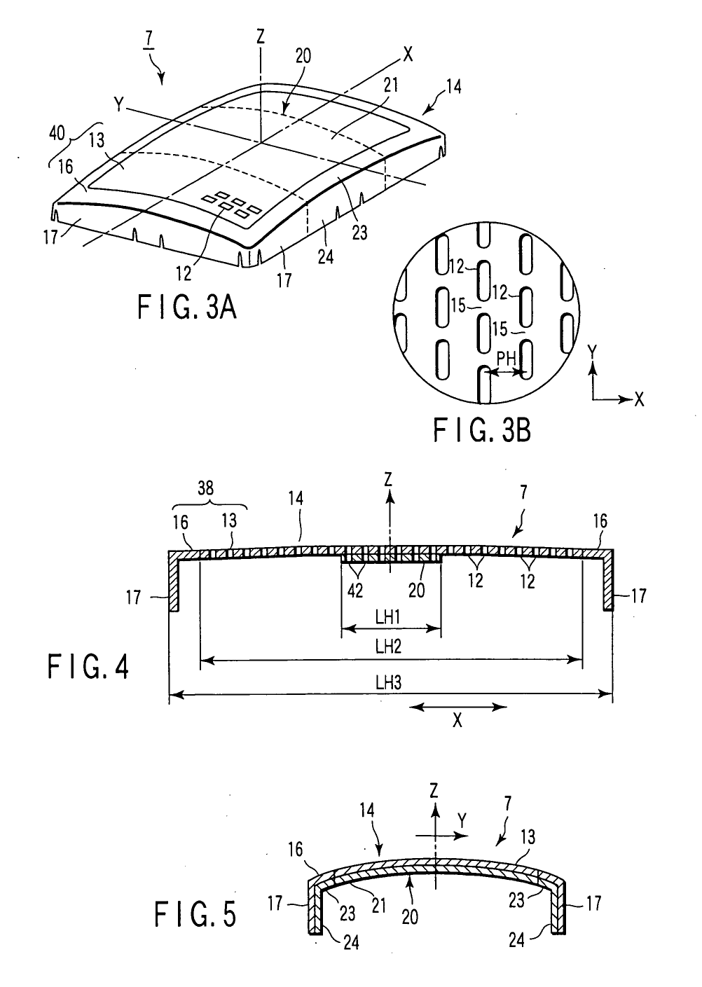

The configuration of the shadow mask 7 will now be described in detail. As shown in FIGS. 3A, 3B, 4 and 5, the shadow mask 7 is provided with a main mask 14 and a sub-mask 20 fixedly lapped on a part of the main mask, and partially has a dual structure.

The main mask 14 is provided integrally with a substantially rectangular mask main surface 38 and a skirt portion 17. The mask main surface 38 is opposed substantially to the whole surface of the phosphor screen 5, and is formed having a given curved shape. The skirt portion 17 extends from the peripheral edge of the mask main surface toward the electron gun in the direction of the tube axis Z. The mask main surface 38 includes a rectangular porous portion 13 and a nonporous portion 16 substantially in the form of a rectangular frame. The porous portion 13 is formed having a large number of apertures 12 that serve as electron beam passage apertures. The nonporous portion 16 is situated surrounding the porous portion and has no apertures. The main mask 14 is formed of a metallic material about 0.1 to 0.25 mm thick. A ferrous material or low-expansion Invar material (Fe—Ni alloy) may be used for the material.

Each aperture 12 of the main mask 14 is substantially in the shape of a rectangle having its width direction coincident with the direction of the major axis X of the porous portion 13. The individual apertures 12 are arranged substantially straight in the direction of the minor axis Y of the porous-portion 13 with bridges 15 between them, thereby forming aperture columns. These aperture columns are arranged in great numbers at array pitches PH of about 0.4 to 0.6 mm in the direction of the major axis X.

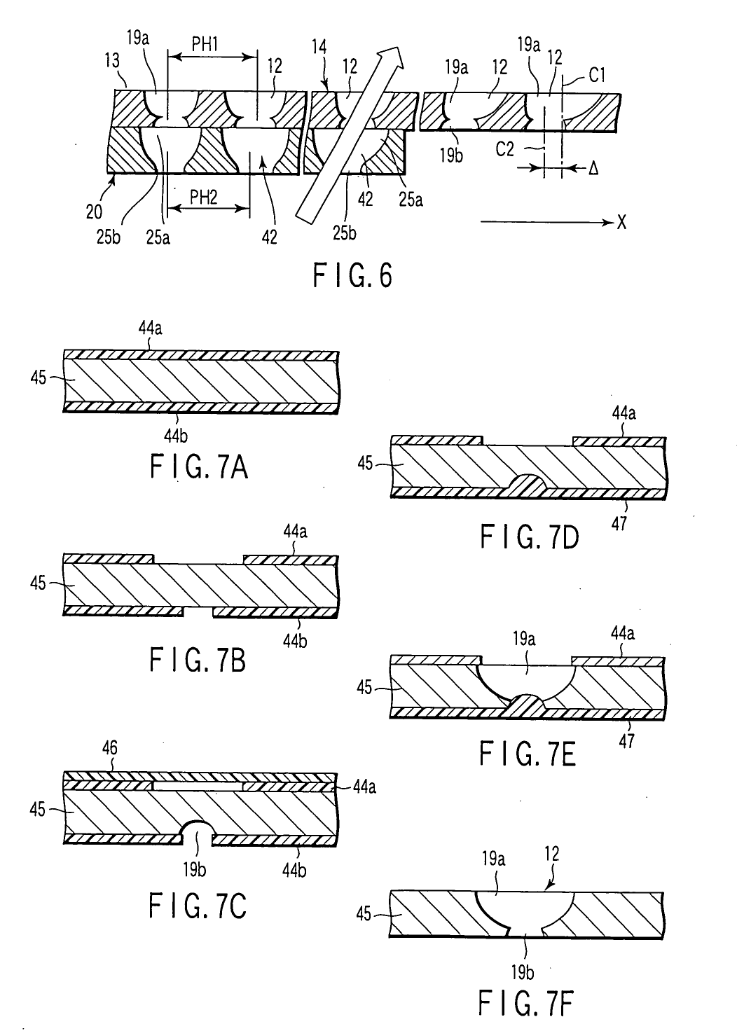

As shown in FIG. 6, each aperture 12 is defined by a through hole in which a substantially rectangular larger hole 19a that opens on the surface of the main mask 14 on the phosphor-screen side internally connects with a substantially rectangular smaller hole 22 that opens on the surface on the electron-gun side.

In those apertures which are situated with deviations on the peripheral side from the center of the porous portion 13, among these apertures 12, a center C1 of the larger hole 19a is offset with respect to a center C2 of the smaller hole 19b for Δ on the peripheral side of the porous portion. The offset distance Δ is greater for the apertures that are situated remoter on the peripheral side from the center of the porous portion 13. This is because after an electron beam passes the smaller hole 19b, it hits and is reflected by the inner surface of the aperture 12, thereby restraining unnecessary light emission from the screen. The larger hole 19a is offset with respect to the smaller hole 19b in both the directions of the minor axis Y and the major axis X of the main mask 14.

As a specific example, the shadow mask is formed of Invar (Fe—Ni alloy), a low-expansion material, having a thickness of 0.22 mm. A plurality of apertures 12 are arranged in a straight line at a array pitch of 0.6 mm in the direction of the minor axis Y of the shadow mask. The aperture columns, each formed of a plurality of apertures in the minor-axis direction, are arranged near the minor axis at pitch of 0.75 mm in the direction of the major axis X and at a pitch of 0.82 mm on the periphery with respect to the major-axis direction. Thus, they are arranged at variable pitches that increase as the periphery with respect to the major-axis direction is approached. The crosswise opening dimension of the larger hole 19a of each aperture 12 is 0.46 mm on the minor axis Y and 0.50 mm in the peripheral portion with respect to the direction of the major axis X. The crosswise opening dimension of the smaller hole 19b is 0.18 mm on the minor axis and 0.20 mm in the peripheral portion with respect to the direction of the major axis. If the electron beam is incident at a deflection angle of 46° upon an aperture 12 that is situated in the peripheral portion with respect to the direction of the major axis X, the offset Δ of the larger hole 19a with respect to the smaller hole 19b of the aperture on the periphery with respect to the direction of the major axis X is 0.06 mm.

As shown in FIGS. 3 to 6, the sub-mask 20 is in the form of an elongate belt, and is fixedly lapped on that region of the inner surface or the electron-gun-side surface of the main mask 14 which contains the minor axis Y of the porous portion 13. The sub-mask 20 is located so that its major-axis direction is coincident with the minor axis Y of the main mask 14. Thus, the shadow mask 7 has, in its region of a given width that contains the minor axis Y, a dual-structure overlapping portion on which the sub-mask 20 is fixed and non-overlapping portions situated individually on the opposite sides of the overlapping portion.

The sub-mask 20, like the main mask 14, is formed of a ferrous material or Invar material, and has a thickness of about 0.25 mm. A width LH1 of the sub-mask 20 in the direction of the major axis X is smaller than a length LH2 of the porous portion 13 in the major-axis direction, and the length in the direction of the minor axis Y is substantially equal to the length of the main mask 14 in the same direction. The sub-mask 20 is provided integrally with a porous portion 21, nonporous portions 23, and a pair of skirt portions 24. The nonporous portions 23 are situated individually on the longitudinally opposite end portions of the sub-mask, outside the porous portion 21. The skirt portions 24 extend from the nonporous portions 23 toward the opposite ends, individually. The porous portion 21 is provided with a large number of apertures 42 for use as electron beam passage apertures corresponding to the apertures 12 of the main mask 14.

The sub-mask 20 is fixed to the electron-gun-side surface of the main mask in a manner such that its porous portion 21, nonporous portions 23, and skirt portions 24 overlap the porous portion 13, nonporous portion 16, and skirt portion 17, respectively, of the main mask 14. Thus, the whole region on the minor axis Y of the main mask 14 has a dual structure.

Each aperture 42 in the porous portion 21 is formed of a through hole in which a substantially rectangular larger hole 25a that opens on the surface of the sub-mask 20 on the phosphor-screen side or on the side of the main mask 14 internally communicates with a substantially rectangular smaller hole 25b that opens on the surface on the electron-gun side. Thus, the sub-mask 20 is fixed to the main mask 14 with the larger holes 25a of the apertures 42 opposed to the main mask 14. The apertures 42 of the sub-mask 20, like the apertures 12 of the main mask 14, form a plurality of aperture columns that extend in the direction of the minor axis Y. These aperture columns are arranged at pitches of about 0.4 to 0.6 mm in the direction of the major axis X. Thus, the apertures 42 are arranged in alignment with the apertures 12 of the main mask 14.

The sub-mask 20 constructed in this manner is fixed to the main mask 14 in intimate contact with it. The main mask 14 and the sub-mask 20 may be fixed by diffusion bonding, called contact bonding, or by laser welding or resistance welding. The sub-mask 20 has at least several fixing points.

In manufacturing the shadow mask 7 in the color cathode ray tube constructed in this manner, the apertures 12 of the main mask 14 are formed by two-step etching, while the apertures 42 of the sub-mask 20 are formed by double-sided etching.

A case of forming the apertures 12 of the main mask 14 by the two-step etching will be described first. A mask blank 45 for main mask, formed of an Invar material, is prepared, for example. Then, resist films 44a and 44b of patterns corresponding to the apertures 12 of the main mask 14 are formed individually on the opposite sides of the mask blank 45, as shown in FIGS. 7A and 7B. Subsequently, an etching protective film 46 of polyester resin or the like is lapped and stuck on the one resist film 44a, and thereafter, an etching solution is sprayed from the side of the other resist film 44b to form a recess for the smaller hole 19b in the mask blank 45, as shown in FIG. 7C.

Then, the resist film 44b is separated, as shown in FIG. 7D, and the surface of the mask blank 45 which has the recess therein is rinsed and dried.

Thereafter, an anti-etching agent, such as paraffin or lacquer, is applied to this surface, whereupon an anti-etching layer 47 is formed so as to fill the recess. The etching protective film 46 that is stuck on the other surface side of the mask blank 45 is separated.

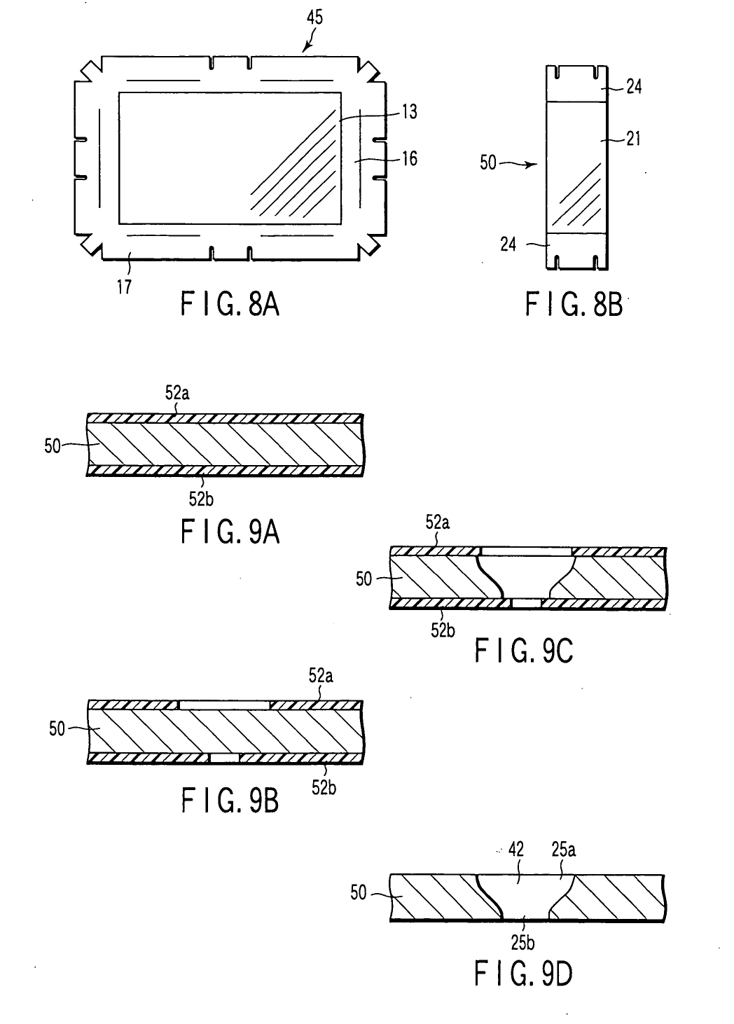

In this state, the etching solution is sprayed on the other surface of the mask blank 45 through the resist film 44a to form the larger hole 19a that communicates with the previously formed recess, as shown in FIG. 7E. Thereafter, a caustic alkaline solution is sprayed, and the anti-etching layer 47 on the other surface and the resist film 44a on the one surface are separated, as shown in FIG. 7F. Thereupon, the flat mask blank 45 having the porous portion 13, in which the numerous apertures 12 of a given diameter are formed at given pitches, can be obtained, as shown in FIG. 8A.

The following is a description of a case of forming the apertures 42 of the sub-mask 20 by the double-sided etching. A mask blank 50 for sub-mask, formed of an Invar material, is prepared, for example. Then, resist films 52a and 52b of patterns corresponding to the apertures 42 of the sub-mask 20 are formed individually on the opposite sides of the mask blank 50, as shown in FIGS. 9A and 9B. Subsequently, the mask blank 50 is continuously etched from the side of the one resist film-or the resist film 52a that corresponds to the larger hole of each aperture 42, whereupon the aperture 42 is formed, as shown in FIG. 9C. Thereafter, the resist films 52a and 52b are separated from the mask blank 50, as shown in FIG. 9D. By doing this, the mask blank 50 for sub-mask shown in FIG. 8B can be obtained.

After the mask blanks 45 and 50 obtained in this manner are then annealed, these mask blanks are accurately positioned with respect to each other as they are lapped on each other, and are fixed to each other by laser welding. Subsequently, the mask blanks 45 and 50 stuck together are press-molded by means of a pressing machine, whereupon a shadow mask of a desired shape is formed such that the sub-mask is situated on the electron-gun-side surface of the main mask.

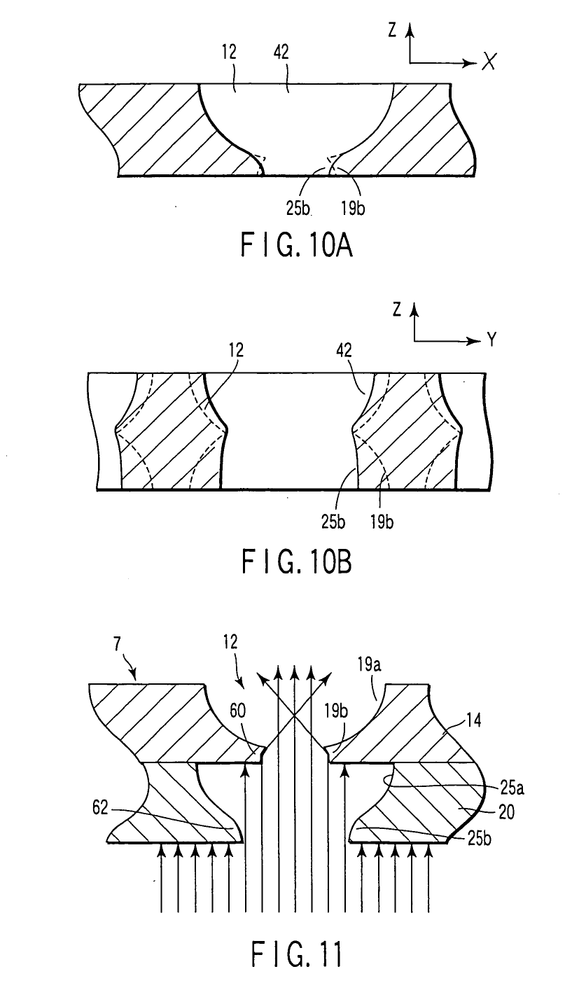

In the shadow mask 7 constructed in this manner, the main mask 14 and the sub-mask 20 are subject to a difference in mask profile shape, as shown in FIGS. 10A and 10B, owing to the difference in etching method. FIG. 10A is a view showing the main mask 14 and the sub-mask 20 with their respective profiles in the direction of the major axis X superposed. Dotted lines represent the aperture 12 of the main mask 14 that is formed by the two-step etching, while full lines represent the aperture 42 that is formed by the double-sided etching. FIG. 10B is a view showing the main mask 14 and the sub-mask 20 with their respective profiles in the direction of the minor axis Y superposed. Dotted and full lines represent the aperture 12 of the main mask 14 and the aperture 42, respectively.

For the profile in the direction of the major axis X shown in FIG. 10A, there is no substantial difference between the apertures 12 and 42. For the profile in the direction of the minor axis Y shown in FIG. 10B, however, the respective profile shapes of the apertures 12 and 42 are considerably different. The two-step etching involves a wider etching range for the aperture formation than the double-sided etching. If the double-sided etching is used, therefore, the remainder or volume of the material that forms the shadow mask 7 is reduced. Thus, the mask of which the apertures are formed by the double-sided etching can have a greater strength.

As for the main mask 14, moreover, its volume and strength can be increased by forming the apertures 12 by the double-sided etching. However, a forming method based on the two-step etching is necessary in order to form smaller apertures that are required for high-definition display. Actually, therefore, it is hard to use double-sided etching for the manufacture of the main mask.

In order to secure an allowance for the alignment with the main mask 14, the sub-mask 20 must be configured to have apertures that are larger than the apertures of the main mask. To attain this, the apertures 42 of the sub-mask 20 are made large enough to cope with the double-sided etching.

According to the shadow mask 7 of the present embodiment, as shown in FIG. 11, the sub-mask 20 having the apertures 42 that are formed by the double-sided etching is stuck on the electron-gun-side surface of the main mask 14 having the apertures 12 that are formed by the two-step etching. The sub-mask 20 is located so that the larger holes 25a of the apertures 42 face the smaller holes 19b of the apertures 12 in the main mask 14.

The apertures 42 of the sub-mask 20 have a size a little larger than the apertures 12 of the main mask 14 with respect to the direction of the major axis X.

This is done to allow for misalignment between the main mask 14 and the sub-mask 20. Preferably, the apertures 42 of the sub-mask 20 should have a size larger than the apertures 12 of the main mask 14 also with respect to the direction of the minor axis Y. In view of the luminance of the phosphor screen, however, the bridge width of the main mask 14 is restricted substantially to a minimum possible value for manufacture. Therefore, the sub-mask 20 and the main mask 14 may be adjusted to the same diameter with respect to the direction of the minor axis Y.

The following is a description of reflection of electron beams in the shadow mask constructed in this manner. As shown in FIG. 11, each of the apertures 12 of the main mask 14 that are formed by the two-step etching has the larger hole 19a and the smaller hole 19b. The diameter of the smaller hole 19b is gradually reduced from the electron-gun-side surface of the main mask 14 toward the larger hole 19a. Thus, a sidewall surface 60 that defines the smaller hole 19b forms a curved surface that inclines toward

the electron gun.

In each of the apertures 42 of the sub-mask 20 that are formed by the double-sided etching, on the other hand, the smaller hole 25b has a substantially fixed diameter or a diameter gradually increased from the electron-gun-side surface of the sub-mask toward the larger hole 25a. Thus, a sidewall surface 62 that defines the smaller hole 25b forms a curved surface that extends substantially parallel to the electron beam or inclines rather toward the phosphor screen without inclining toward the electron gun.

Each electron beam that is emitted from the electron gun toward the shadow mask 7 passes through each aperture 42 of the sub-mask 20 and each aperture 12 of the main mask 14 and lands on the phosphor screen. As this is done, the electron beam passes through the aperture 42 without practically generating any secondary electrons, since the smaller hole 25b of the aperture 42 in the sub-mask 20 has no sidewall surface that faces the electron gun, that is, no sidewall surface that is hit by the electron beam.

On the other hand, the electron beam having passed through the aperture 42 of the sub-mask 20 lands on the aperture 12 of the main mask 14, and most of it passes through the aperture 12 and reaches the phosphor screen. A part of the electron beam incident on the aperture 12 hits the sidewall surface 60 that defines the smaller hole 19b, thereby emitting secondary electrons. Some of the emitted secondary electrons pass through the aperture 12 of the main mask 14 and reach the phosphor screen. These secondary electrons cause unwanted light emission from a part of the phosphor screen.

Only few secondary electrons are generated, as described above, since the sub-mask 20, having the apertures 42 formed by the double-sided etching, practically has no smaller-hole-side surface that is hit by the electron beam. Accordingly, the electron beam is reflected by the sidewall surface 60 of the main mask 14 only. These secondary electrons are generated in the same state for the non-overlapping portions of the main mask 14 on which the sub-mask 20 is not stuck. Although slight unwanted light emission from the phosphor screen occurs, therefore, the difference in unwanted light emission between that part of the shadow mask 7 which corresponds to the overlapping portion and the parts corresponding to the non-overlapping portions can be eliminated. Thus, a satisfactory image can be obtained without causing undesired distinctions in brightness or belt-shaped boundaries to appear on the display screen.

Unwanted light emission (of which a description is omitted) is also caused in like manner with respect to the direction of the minor axis Y. Fewer secondary electrons are emitted from the sub-mask 20, having the apertures 42 that are formed by double-sided etching, than from the main mask 14. Thus, generation of distinctions in brightness or boundaries that are attributable to unwanted light emission from the phosphor screen can be prevented.

In forming, for example, stripe-shaped phosphor layers by exposure using the shadow mask 7, in the manufacture of the color cathode ray tube, the generation of unwanted light emission can be made substantially uniform throughout the area in the same manner as aforesaid. Accordingly, the width of the phosphor layers of the phosphor screen can be made substantially uniform in both the region opposite the overlapping portion and the regions corresponding to the non-overlapping portions. In consequence, the color cathode ray tube can be obtained ensuring an improved display image quality level.

According to the color cathode ray tube constructed in this manner, the sub-mask 20 is lapped on the main mask 14. Therefore, deformation can be restrained near the center of the screen in which the shadow mask 7 is most liable to be deformed. In consequence, the curved surface strength of the mask can be improved. By forming the apertures of the sub-mask by the double-sided etching, in particular, a satisfactory volume can be secured for the mask material after the formation of the apertures, so that the mask strength can be maintained. Further, the apertures of the sub-mask are formed by the double-sided etching, and are configured so that each aperture has no sidewall surface that inclines on the electron-gun side or that the sidewall surface that inclines on the electron-gun side is smaller than the sidewall surface on the main-mask side. Thus, a satisfactory image can be obtained without causing undesired distinctions in brightness that are attributable to differences in unwanted light emission and phosphor screen between the overlapping portion and the non-overlapping portions of the shadow mask.

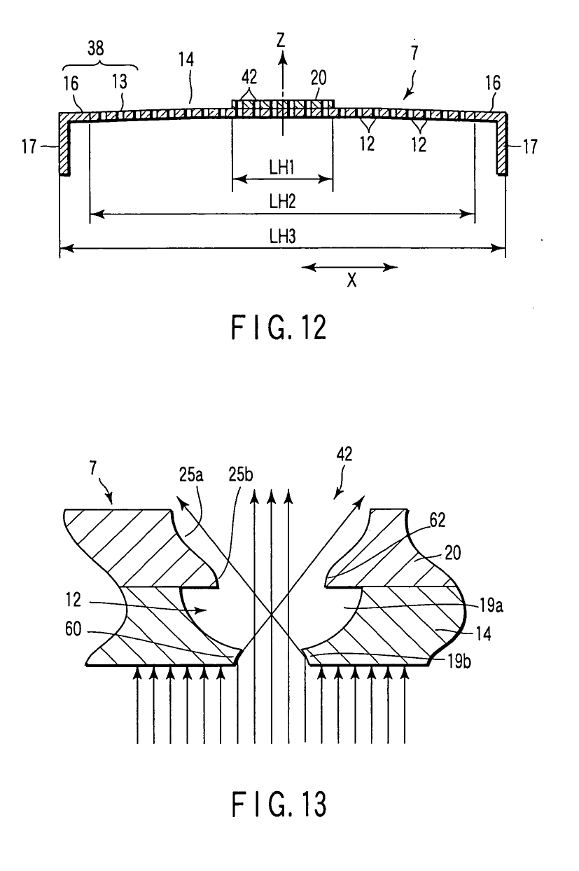

This invention is not limited to the embodiment described above, and various changes may be effected therein without departing from the scope of the invention. In the embodiment described above, for example, the sub-mask 20 is located on the electron-gun side of the main mask 14. As shown in FIGS. 12 and 13, however, the sub-mask 20 may be located on the outer surface side of the main mask 14, that is, on the surface on the side of the phosphor screen 5. In this case, the sub-mask 20 is fixed to the main mask 14 in a manner such that the smaller hole 25b of each aperture 42 faces the main mask 14. The same functions and effects as aforesaid can be also obtained with use the shadow mask constructed in this manner. This embodiment shares other configurations with the foregoing embodiment, so that like reference numerals are used to designate like portions, and a detailed description of those portions is omitted.

The sub-mask is not limited to one in number, and a plurality of sub-masks may be provided instead. Further, each aperture of the shadow mask is not limited to the rectangular shape, and may be utilized effectively if it is round.

What is claimed is:

1. A color cathode ray tube comprising:
a panel having a phosphor screen on an inner surface thereof;
an electron gun which emits electron beams toward the phosphor screen; and
a substantially rectangular shadow mask located opposite the phosphor screen inside the panel and having a major axis and a minor axis extending at right angles to each other and to a tube axis,
the shadow mask including:
a main mask having a substantially rectangular porous portion opposed to substantially the whole surface of the phosphor screen and having a number of electron beam passage apertures, and
a belt-shaped sub-mask fixed to a region containing the minor axis of the porous portion of the main mask, having a number of electron beam passage apertures corresponding individually to the electron beam passage apertures of the main mask, and
a longitudinal direction of the sub-mask being on the minor axis,
each of the electron beam passage apertures of the main mask being defined by a through hole in which a larger hole opening on a surface of the main mask on the phosphor-screen side internally communicates with a smaller hole opening on a surface of the main mask on the electron-gun side,
each of the electron beam passage apertures of the sub-mask being defined by a through hole in which a larger hole opening on one surface of the sub-mask internally communicates with a smaller hole opening on the other surface of the sub-mask,
each of the smaller holes of the main mask having a diameter gradually reduced from the electron-gun-side surface of the main mask toward the larger hole, and each of the smaller holes of the sub-mask having a substantially fixed diameter or a diameter gradually increased from the other surface of the sub-mask toward the larger hole.

2. A color cathode ray tube according to claim 1, wherein the main mask has a sidewall surface which defines each smaller hole, inclines toward the electron gun, and is hit by an electron beam, and the sub-mask has a sidewall surface which defines each smaller hole and extends substantially parallel to the electron beam or inclines toward the phosphor screen.

3. A color cathode ray tube according to claim 1, wherein the electron beam passage apertures of the main mask are formed by two-step etching, and the electron beam passage apertures of the sub-mask are formed by double-sided etching.

4. A color cathode ray tube according to claim 1, wherein the sub-mask is lapped on the electron-gun-side surface of the main mask.

5. A color cathode ray tube according to claim 1, wherein the larger-hole-side surface of the sub-mask is in contact with the smaller-hole-side surface of the main mask.

6. A color cathode ray tube according to claim 1 or 2, wherein the sub-mask is lapped on the phosphor-screen-side surface of the main mask.

7. A color cathode ray tube according to claim 2, wherein the electron beam passage apertures of the main mask are formed by two-step etching, and the electron beam passage apertures of the sub-mask are formed by double-sided etching.

8. A color cathode ray tube according to claim 2, wherein the sub-mask is lapped on the electron-gun-side surface of the main mask.

9. A color cathode ray tube according to claim 2, wherein the larger-hole-side surface of the sub-mask is in contact with the smaller-hole-side surface of the main mask.

10. A color cathode ray tube according to claim 2, wherein the sub-mask is lapped on the phosphor-screen-side surface of the main mask.

11. A method of manufacturing a color cathode ray tube, which comprises a panel having a phosphor screen on the inner surface thereof, an electron gun which emits electron beams toward the phosphor screen, and a substantially rectangular shadow mask located opposite the phosphor screen inside the panel and having a major axis and a minor axis extending at right angles to each other and to a tube axis, the shadow mask including a main mask having a substantially rectangular porous portion opposed to substantially the whole surface of the phosphor screen and having a number of electron beam passage apertures, and a belt-shaped sub-mask fixed to a region containing the minor axis of the porous portion of the main mask, having a number of electron beam passage apertures corresponding individually to the electron beam passage apertures of the main mask, and a longitudinal direction of the sub-mask being on the minor axis, the method comprising:
preparing a flat mask blank for the main mask and a flat mask blank for the sub-mask;
etching the mask blank for the main mask by two-step etching, thereby forming a plurality of electron beam passage apertures each defined by a through hole in which a larger hole opening on one surface of the mask blank internally communicates with a smaller hole opening on the other surface of the mask blank;
etching the mask blank for the sub-mask by double-sided etching, thereby forming a plurality of electron beam passage apertures each defined by a through hole in which a larger hole opening on one surface of the mask blank internally communicates with a smaller hole opening on the other surface of the mask blank;
fixing together the mask blank for the main mask and the mask blank for the sub-mask, having the electron beam passage apertures each; and
press-molding the fixed mask blanks into a desired shape, thereby forming the shadow mask.

12. A method of manufacturing a color cathode ray tube according to claim 11, wherein the mask blanks are fixed by laser welding in a manner such that the larger-hole-side surface of the mask blank for the sub-mask is in contact with the smaller-hole-side surface of the mask blank for the main mask, and the mask blanks are press-molded so that the sub-mask is situated on the electron-gun side of the main mask.
